(19) United States
(12) Patent Application Publication
(10) Pub. No.: US 2009/0041024 A1
(43) Pub. Date: Feb. 12, 2009

(54) Supporting a Transmission and a Reception of Data Packets

(75) Inventors: Ville Steudle, Turku (FI); Jussi Numminen, Turku (FI); Matti Jokimies, Salo (FI); Antti Toskala, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION, Espoo (FI)

(21) Appl. No.: 12/224,356

(22) PCT Filed: Apr. 21, 2005
(86) PCT No.: PCT/IB2005/001070

§ 371 Date: Aug. 20, 2008

(51) Int. Cl. H04L 12/56

(52) U.S. Cl. 370/395.3

(57) ABSTRACT

In order to enable a more efficient use of an available transmission capacity, a transmitting device (10) assigns at least one identifier in common to at least two receiving devices (20, 30, 40). Further, it signals the at least one identifier to each of the receiving devices. A receiving device (20) receives and registers such a common identifier. Thereafter, the transmitting device announces a respective transmission of data packets for at least one of the receiving devices on a transmission channel by signaling the at least one common identifier. The receiving device (20) receives and detects such an identifier, which is used by the transmitting device (10) for announcing a transmission of data packets. The receiving device then extracts data packets for the receiving device from data packets on the transmission channel announced by the detected identifier.

### FIELD OF THE INVENTION

The invention relates to a method for supporting a transmission of data packets on a transmission channel, to a corresponding transmitting device, to a corresponding chip, to a corresponding software code and to a corresponding software program product. The invention relates equally to a method for supporting a reception of data packets on a transmission channel, to a corresponding receiving device, to a corresponding chip, to a corresponding software code and to a corresponding software program product. The invention relates further to a communication system comprising a transmitting device and a receiving device.

### BACKGROUND OF THE INVENTION

Transmissions in a communication network can be either circuit switched or packet switched. Particularly efficient packet based downlink transmissions from a network element of a mobile communication networks to a user equipment entity are enabled by the High Speed Downlink Packet Access (HSDPA).

HSDPA is based on the Wideband Code Division Multiple Access (WCDMA), which is employed for Universal mobile telecommunication services (UMTS) systems. HSDPA was introduced in release 5 of the 3rd Generation Partnership Program (3 GPP) specifications. Compared to conventional WCDMA, it improves the system capacity and increases the user data rates by several measures. HSDPA is able to adapt the modulation scheme and the coding according to the quality of the radio link. Moreover, the scheduling of data packets over the air interface is performed in the base station and using a short frame length. Finally, requests for retransmissions of data packets by a terminal are equally processed in the base station, which is moreover using an incremental redundancy in retransmissions.

The transport channel employed by HSDPA, which is called High Speed Downlink Shared Channel (HS-DSCH), further takes into account the bursty packet data. While the WCDMA system normally carries user data over dedicated transport channels, the HS-DSCH allows multiplexing the data packets for several users so that during silent periods, the resources are available to other users.

In the technical specification 3 GPP TS 25.211 V6.3.0 (2004-12): “Physical channels and mapping of transport channels onto physical channels (FDD)” (Release 6), it is defined that the HS-DSCH is associated with one or several Shared Control Channels (HS-SCCH). The HS-DSCH is divided into subframes of 2 ms. All related signaling, including Hybrid Automated Repeat Request Acknowledgements or Non-Acknowledgements (HARQ ACK/NACK) and Channel Quality Indicator (CQI) based quality reports, are based on this 2 ms time grid as well.

Each subframe, or Transmission Time Interval (TTI), is dedicated to a particular user equipment entity based on an HS-DSCH Radio Network Temporary Identifier (H-RNTI), which is signaled to the user equipment entity. In the technical specification 3 GPP TS 25.331 V6.4.0 (2004-12):

“Radio Resource Control (RRC); Protocol Specification” (Release 6), the H-RNTI is defined to be user equipment specific. The user equipment entity uses its assigned H-RNTI to identify from messages on the HS-SCCH which transmissions it has to receive.

In future cellular networks which are based on the Universal Terrestrial Radio Access (UTRA) Frequency Division Duplex (FDD) with HSDPA, for example, more and more services could be moved from circuit switched connections to packet switched connections. This may result in gains, for example due to unified transport bearers and trunking.

Currently, HSDPA is only optimized for high data-rate http/ftp/streaming type services, though, not for low data-rate interactive services. When HSDPA is used to transmit Internet Protocol (IP) based interactive services, like voice over IP, the data packets which have to be transmitted at a time are rather small. The HS-DSCH TTI size of 2 ms might be unnecessarily large for such small data packets.

Voice data frames, for example, are usually created every 20 ms. The data rates could lie for instance between 4.75 and 12.2 kbps when using an Adaptive Multi-Rate (AMR) codec. This corresponds approximately to 95 to 244 bits of voice data per 20 ms, plus some overhead. The overhead may comprise for example headers, which are usually compressed. To optimize the cell capacity, it is desirable to transmit this data using one single data block per 20 ms. Currently, with good channel conditions, the HSDPA data capacity for a single user equipment entity for one code and one TTI could be up to 1838 bits.

This capacity is much higher than the bits required for one voice data frame.

Thus, in good channel conditions, bandwidth and capacity is wasted.

Alternative approaches, like those presented for voice optimisations in IP Multimedia Subsystem (IMS), which use dedicated channels and possibly secondary scrambling codes, are rather clumsy and inefficient.

### SUMMARY OF THE INVENTION

It is an object of the invention to enable a more efficient use of an available transmission capacity.

For a transmitting end, a method for supporting a transmission of data packets on a transmission channel is proposed. The method comprises at a transmitting device assigning at least one identifier in common to at least two receiving devices. The method further comprises signaling the at least one identifier to each of the at least two receiving devices. The method further comprises announcing a respective transmission of data packets for at least one of the at least two receiving devices on the transmission channel by signaling the at least one identifier.

For a transmitting end, moreover a transmitting device supporting a transmission of data packets on a transmission channel is proposed. The transmitting device comprises processing means adapted to assign at least one identifier in common to at least two receiving devices. The transmitting device further comprises processing means adapted to cause a signaling of the at least one identifier to each of the at least two receiving devices. The transmitting device further comprises processing means adapted to announce a respective transmission of data packets for at least one of the at least two receiving devices on the transmission channel by causing a signaling of the at least one identifier.

The proposed transmitting device can be any device which is able to transmit packets switched data streams in parallel to a plurality of receiving devices. It can be for example, though not exclusively, a network element of a communication network, like a base station or a radio network controller (RNC) of a mobile communication network. The respective processing means can be realized in hardware and/or in software. It may also be some processing unit running a software code.

For a transmitting end, moreover a chip for a transmitting device supporting a transmission of data packets on a transmission channel is proposed. The chip comprises a hardware portion adapted to assign at least one identifier in common to at least two receiving devices. The chip further comprises a hardware portion adapted to cause a signaling of the at least one identifier to each of the at least two receiving devices. The chip further comprises a hardware portion adapted to announce a respective transmission of data packets for at least one of the at least two receiving devices on the transmission channel by causing a signaling of the at least one identifier. The chip is thus provided for the case the processing means of the transmitting device are to be realized in hardware.

For a transmitting end, moreover a software code for supporting a transmission of data packets on a transmission channel is proposed. When running in a processing unit of a transmitting device the software code assigns at least one identifier in common to at least two receiving devices and causes a signaling of this at least one identifier to each of the at least two receiving devices. Further, it announces a respective transmission of data packets for at least one of the at least two receiving devices on the transmission channel by causing a signaling of the at least one identifier. The software code is thus provided for the case the processing means of the transmitting device are to be realized in software or comprising software.

For a transmitting end, finally a software program product is proposed, in which the software code proposed for the transmitting end is stored.

For a receiving end, a method for supporting a reception of data packets on a transmission channel is proposed. The method comprises at a receiving device receiving and registering at least one identifier, which registered identifier has been assigned by a transmitting device in common to the receiving device and at least one further receiving device. The method further comprises receiving and detecting an identifier, which detected identifier corresponds to a registered identifier, in case the registered identifier is used by a transmitting device for announcing a transmission of data packets for at least one of the receiving device and at least one further receiving device. The method further comprises extracting data packets for the receiving device from data packets on the transmission channel announced by the detected identifier.

For a receiving end, moreover a receiving device supporting a reception of data packets on a transmission channel is proposed. The receiving device comprises processing means adapted to register at least one identifier received by the receiving device, which registered identifier has been assigned by a transmitting device in common to the receiving device and at least one further receiving device. The receiving device further comprises processing means adapted to detect an identifier received by the receiving device and corresponding to a registered identifier, in case the registered identifier is used by a transmitting device for announcing a transmission of data packets for at least one of the receiving device and at least one further receiving device. The receiving device further comprises processing means adapted to extract data packets for the receiving device from data packets on the transmission channel announced by a detected identifier.

The receiving device can be any device which is able to receive packet switched data. It can be for example, though not exclusively, a user equipment entity, like a mobile terminal. The respective processing means can be realized again in hardware and/or in software. It may also be some processing unit running a software code.

For a receiving end, moreover a chip for a receiving device supporting a reception of data packets on a transmission channel is proposed. The chip comprises a hardware portion adapted to register at least one identifier received by the receiving device, which registered identifier has been assigned by a transmitting device in common to the receiving device and at least one further receiving device. The chip further comprises a hardware portion adapted to detect an identifier received by the receiving device and corresponding to a registered identifier, in case the registered identifier is used by a transmitting device for announcing a transmission of data packets for at least one of the receiving device and at least one further receiving device. The chip further comprises a hardware portion adapted to extract data packets for the receiving device from data packets on the transmission channel announced by a detected identifier. The chip is thus provided for the case the processing means of the receiving device are to be realized in hardware.

For a receiving end, moreover a software code for supporting a reception of data packets on a transmission channel is proposed. When running in a processing unit of a receiving device, the software code registers at least one identifier received by the receiving device, which registered identifier has been assigned by a transmitting device in common to the receiving device and at least one further receiving device. The software code further detects an identifier received by the receiving device, which detected identifier corresponds to a registered identifier, in case the registered identifier is used by a transmitting device for announcing a transmission of data packets for at least one of the receiving device and at least one further receiving device. The software code further extracts data packets for the receiving device from data packets on the transmission channel announced by the detected identifier. The software code is thus provided for the case the processing means of the receiving device are to be realized in software or comprising software.

For a receiving end, finally a software program product is proposed, in which the software code proposed for the receiving end is stored.

Moreover a communication system is proposed, which comprises a transmitting device as proposed for the transmitting end and at least one receiving device as proposed for the receiving end.

The invention proceeds from the consideration that it is not necessary to assign a separate identifier to each receiving device to which data packets are to be transmitted. It is proposed that at least one identifier is assigned by a transmitting device in common to at least two receiving devices, which at least one common identifier is then used by the transmitting device to announce a respective transmission of data packets for one or more of these receiving devices. It is further proposed that a receiving device registers at least one assigned common identifier and detects an announcement of a transmission comprising at least data packets for itself based on this at least one common identifier.

It is an advantage of the invention that it allows using available transmission capacities in a particularly flexible and efficient manner. The invention enables the transmitting device to use a single transmission entity, for instance a single transmission interval, for data packets which are addressed to several devices. Thus, a respective transmission entity does not have to be reserved any more for a single receiving device. This is of particular interest, if the capacity in one transmission entity is much larger than the size of the data packets that are currently to be transmitted to a plurality of receiving devices. Consequently, the transmitting device can use the available capacity more optimally. The at least one common identifier allows notifying each receiving device for which data packets may be provided.

It is further an advantage of the invention that it is easy to implement.

A respective transmission of data packets for at least one of the at least two receiving devices, which is announced by the at least one identifier, may be a transmission in any kind of transmission entity.

In one embodiment of the invention, the data packets are transmitted on the transmission channel in fixed transmission time intervals, and a transmission of data packets for at least one of the at least two receiving devices in a respective transmission time interval is announced by signaling the at least one common identifier.

If the invention is employed for HSDPA, the transmission time interval may correspond for example to an HSDPA TTI having a length of 2 ms.

In order to be able to transmit data packets for more than one receiving device in a single transmission time interval, a transmission time interval may be divided into at least two sub intervals. A respective sub interval is suited for transmitting smaller data packets than the original transmission time interval. At least one of these sub intervals may then be associated to a respective one of the at least two receiving devices. Each sub interval associated to one of the receiving devices can then be used for transmitting data packets for this receiving device. Instead of using the entire transmission time interval for a single receiving device, it can thus be shared among different receiving devices by multiplexing and rate-matching data for different receiving devices into the same transmission time interval.

Sharing a single transmission time interval has the advantage that it enables a large capacity gain for continuous low-data rate packet services, like voice over IP, gaming, chat or machine-to-machine communications. If the sub intervals are only a fraction of an entire transmission time interval, the payload size fits better to low data rate services and may yield a significant capacity increase.

When employed with HSDPA, a high level of compatibility with previous implementations can be achieved. For example, each receiving device would still receive only one packet per 2 ms TTI. This allows keeping the currently defined signaling, in particular the HS-SCCH, the HARQ ACK/NACK signaling and the CQI quality reports, almost the same.

A transmission time interval may be divided into a fixed number of sub intervals or into a variable number of sub intervals. A HSDPA TTI, for example, comprises three time slots. A transmission time interval, in which data packets for at least one of the at least two receiving devices is to be transmitted, may then be divided into sub intervals corresponding to a respective timeslot. It is to be understood that the association of sub intervals to the at least two receiving devices can be selected freely and be changed from one concerned transmission time interval to the next.

Using a fixed number of sub intervals has the advantage that the complexity of the implementation is particularly low. In the case of HSDPA, a splitting into three sub intervals would result in sub intervals of approximately 600 bits, which is sufficient for a respective voice data frame in the above presented example. In this case, a threefold capacity increase would be achieved. The interleaving gain will be smaller with one time slot than, for example, with three time slots. Still, even with 3 time slots, the interleaving gain is small and it can be compensated by a fast HARQ mechanism.

Alternatively, each transmission time interval, in which data packets for at least one of the at least two receiving devices is to be transmitted, may be divided into a number of sub intervals, which is determined based on the current transmission capacity and/or the currently required data rate. In the case of HSDPA and data rates of 4.75 kbps to 12.2 kbps, mentioned above by way of example for voice data frames, a transmission time interval could be split for instance into three to eighteen sub intervals. The allowed options could also be more limited, however, in order to keep the complexity low.

Also with a varying number of sub intervals, the resulting complexity of the implementation is still rather low. Moreover, a varying number enables more alternatives of sharing a transmission time interval, and the interleaving gain will be larger than with a fixed number of sub intervals.

In one embodiment of the invention, the at least one common identifier is a single identifier. Such a single identifier can be processed by a receiving device just like an identifier which is assigned exclusively to this receiving device. This embodiment can be implemented easily with a low complexity. In the case of HSDPA, the identifier is an H-RNTI. No changes in H-RNTI processing are required at the receiving end. By assigning the same H-RNTI to a group of receiving devices, several receiving devices are instructed to receive during the same 2 ms TTIs marked with this H-RNTI.

In another embodiment of the invention, the at least one common identifier belongs to a respective set of identifiers assigned to each of the at least two receiving devices. Each set of identifiers is signaled to a respective one of the at least two receiving devices to which the set of identifiers is assigned. In this case, the receiving device may perform a detection run sequentially for each of the identifiers. Alternatively, the receiving device may perform a parallel detection for all identifiers. The sets of identifiers can be different for different receiving devices; they only have to comprise at least one common identifier for at least two receiving devices. A respective set can be selected for instance depending on the radio conditions or the required data rate, which may be related for example to a Voice over IP codec coding rate. By assigning a respective set of identifiers to the receiving devices, thus the flexibility in scheduling the data for different receiving devices is increased. In the case of HSDPA, the sets of identifiers are sets of H-RNTIs. By assigning a set of H-RNTIs to a receiving device, the receiving device is instructed to receive during any 2 ms TTI marked with any of the H-RNTIs within the set.

The receiving device has to known whether a transmission time interval may comprise data packets addressed to the receiving device, which his achieved by means of the at least one identifier. In addition, it has to known which sub interval of such a transmission time interval comprise data packets for the receiving device.

In one embodiment of the invention, therefore a position information for a sub interval in a respective transmission time interval is signaled to a receiving device to which this sub interval is associated. The position information can be signaled in various ways.

In a first possible approach, the position information is signaled as a higher layer signaling. In the case of HSDPA, this approach has the advantage that it has no impact on the current HS-SCCH. Compared to other approaches, it is rather slow.

In a second possible approach, the position information is signaled as an explicit layer 1 (L1) signaling. In the case of HSDPA, this approach has the advantage that it is fast and that a fully dynamic allocation is enabled. It requires some field definition changes for the HS-SCCH.

In a third possible approach, the position information is signaled as an implicit layer 1 (L1) signaling, for example by an identifier masking or a coloring of the data part. In the case of HSDPA, also this approach has the advantage that it has no impact on the current HS-SCCH. The processing at the receiving end is somewhat increased due to the resulting “blind” detection scheme.

In a fourth possible approach, the position information is signaled as an in-band signaling, for example multiplexed into the data. In the case of HSDPA, also this approach has the advantage that it has no impact on the current HS-SCCH. This approach requires a somewhat more complicated control plane architecture and a second method for a startup, for example using an RRC signaling.

In either approach, the position information may indicate a bit position within a transmission time interval. The bit position is to be used by the receiving device for extracting the data packets from the correct sub interval of an identified transmission time interval. Several different bit positions could be signaled as well, meaning that different amounts of data per sub interval would be possible as well.

The data packets for a respective receiving device could be scrambled and/or ciphered by the transmitting device in order to prevent eavesdropping problems. Alternatively, the entire data stream for a respective receiving device could be scrambled and/or ciphered at a higher stage of the transmission chain. Only the receiving device for which the data packets are intended is enabled to descramble and/or decipher the data packets correctly.

The invention has the advantage that it can be realized in a backward compatible way. Thus, it can easily be deploy in mixed systems comprising receiving devices according to the invention and in addition conventional receiving devices.

### BRIEF DESCRIPTION OF THE FIGURES

Other objects and features of the present invention will become apparent from the following detailed description considered in conjunction with the accompanying drawings.

FIG. 1 is a schematic block diagram of a communication system according to an embodiment of the invention;

FIG. 2 is a flow chart illustrating an operation in the system of FIG. 1;

FIG. 3 illustrates a conventional use of an HSDPA TTI;

FIG. 4 illustrates a first exemplary use of an HSDPA TTI in the system of FIG. 1;

FIG. 5 illustrates a second exemplary use of an HSDPA TTI in the system of FIG. 1; and

FIG. 6 illustrates possible distributions of subframes to different terminals in the first exemplary use of an HSDPA TTI illustrated of FIG. 4.

### DETAILED DESCRIPTION OF THE INVENTION

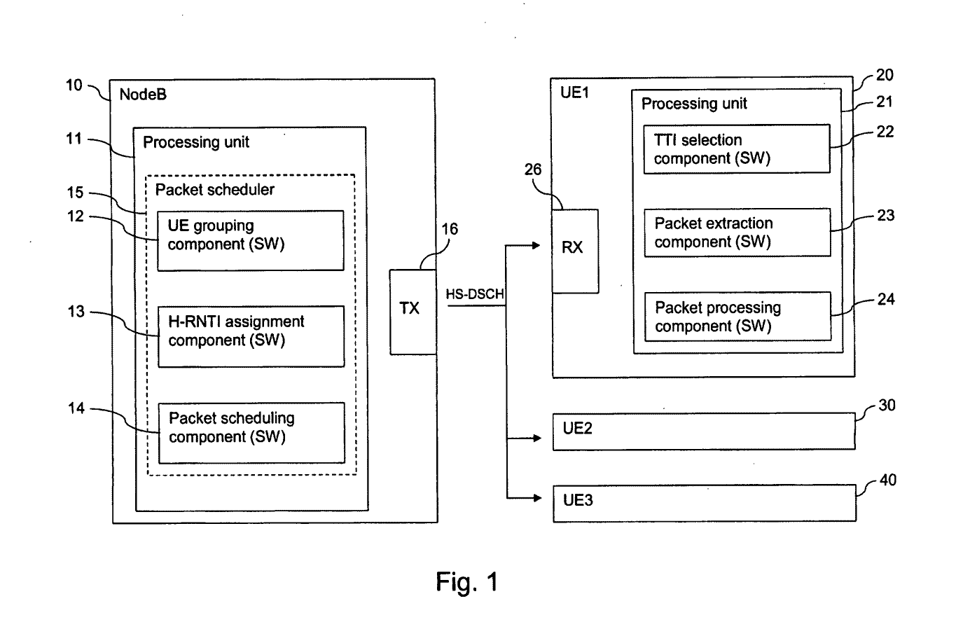

FIG. 1 is a schematic block diagram of a communication system, in which a transmission time interval of a downlink transmission channel can be shared by several users in accordance with the invention.

The communication system comprises a network element 10 of a communication network and a plurality of user equipment entities UE1 20, UE2 30, UE3 40.

By way of example, the network element 10 is a NodeB of an UTRAN (UMTS terrestrial radio access network) supporting HSDPA.

The NodeB 10 comprises a processing unit 11 which is able to run various software components. The implemented software components comprise a UE grouping component 12, an H-RNTI assignment component 13 and a packet scheduling component 14. These components 12, 13, 14 form an HSDPA packet scheduler 15. The NodeB 10 further comprises a transmitter TX 16 for transmitting data via the radio interface, and other conventional components of a NodeB. It is to be understood that the functions of components 12, 13 and 14 could alternatively be realized in hardware, for instance as separate or interleaved hardware portions implemented on a chip.

The user equipment entities 20, 30, 40 can be for example mobile phones and/or other mobile terminals supporting HSDPA. They will be referred to in the following as terminals 20, 30, 40.

Only for one of the terminals 20, components relevant to the invention are shown in more detail. The other terminals 30, 40 may be designed in a similar manner.

The terminal 20 comprises equally a processing unit 21 which is able to run various software components. The implemented software components comprise a TTI selection component 22, a packet extraction component 23 and a packet processing component 24. The terminal 20 further comprises a receiver RX 26 for receiving data via the radio interface, and other conventional components of a terminal. It is to be understood that also the functions of components 22, 23 and 24 could alternatively be realized in hardware, for instance as separate or interleaved hardware portions implemented on a chip.

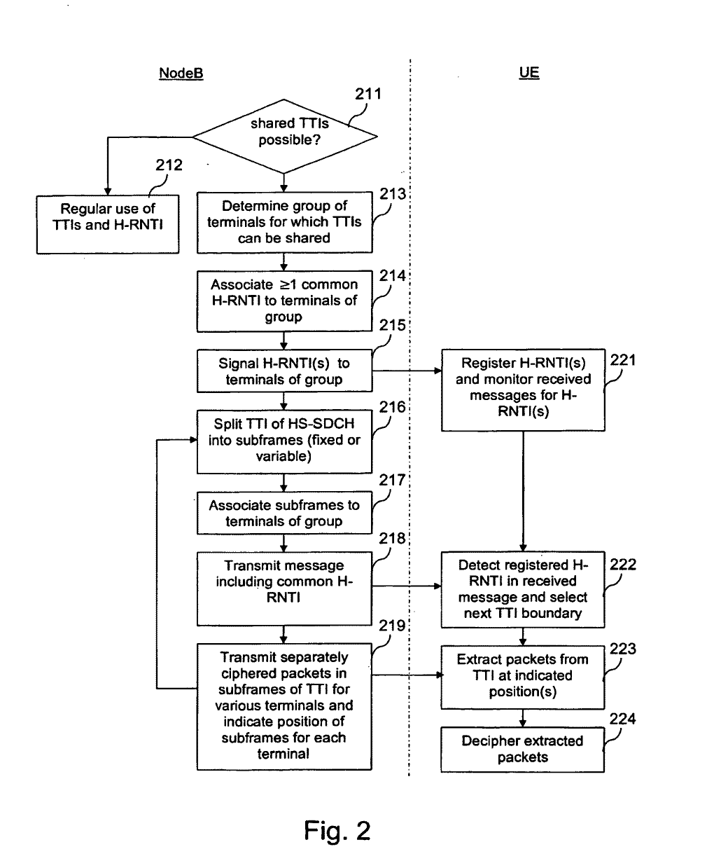

The operation in the system according to the invention will now be explained with reference to FIG. 2. FIG. 2 is a flow chart, which presents on the left hand side a processing in the NodeB 10 and on the right hand side a processing in the terminal 20.

For all new downlink transmissions, the UE grouping component 12 of the NodeB 10 checks first whether a shared use of HS-DSCH TTIs for downlink transmissions to a plurality of terminals 20, 30, 40 is appropriate (step 211).

For high-data rate packet services, a shared use is not considered to be appropriate. In these cases, HS-DSCH TTIs are employed in a conventional manner for the downlink transmissions. Also an H-RNTI is associated to a single terminal in a conventional manner for enabling the terminal to identify TTIs comprising packets for this terminal. (step 212)

For all low-data rate packet services, like voice over IP, gaming, chat and machine-to-machine services, in contrast, a shared use is generally considered to be appropriate. In these cases, several terminals 20, 30, 40 that are involved in such services are combined in a respective group (step 213).

Next, the H-RNTI assignment component 13 associates a single, common H-RNTI to this group of terminals (step 214). The single H-RNTI is then signaled on the HS-SCCH to each of the terminals 20, 30, 40 of the group (step 215). It has to be noted that alternatively, a respective set of H-RNTIs comprising the common H-RNTI and H-RNTIs for arbitrary other TTIs could be assigned to the terminals of the group in step 214. In this case, the respective set of H-RNTIs is signaled in step 215 to each of the terminals 10, 20, 30. As a result, the same and/or different TTIs can be employed flexibly for the terminals 20, 30, 40 of a group.

The terminal 10 receives the H-RNTI or the set of H-RNTIs on the HS-SCCH. The TTI selection component 22 registers the received H-RNTI or the received set of H-RNTIs, which may include detecting and storing the H-RNTI or the set of H-RNTIs. Further, the TTI selection component 22 monitors whether any messages comprises a registered H-RNTI is received on the HS-SCCH. (step 221) In the case of a single registered H-RNTI, the monitoring corresponds to a conventional detection of H-RNTIs. In the case of a set of registered H-RNTIs, the TTI selection component 22 may perform a respective conventional detection run sequentially for all H-RNTIs. Alternatively, the TTI selection component 22 could use a different algorithm for a parallel detection of any of the H-RNTIs.

In the meantime, the packet scheduling component 14 of the NodeB splits up the currently upcoming TTI into subframes (step 216). Each subframe begins thus at a particular bit position in the TTI.

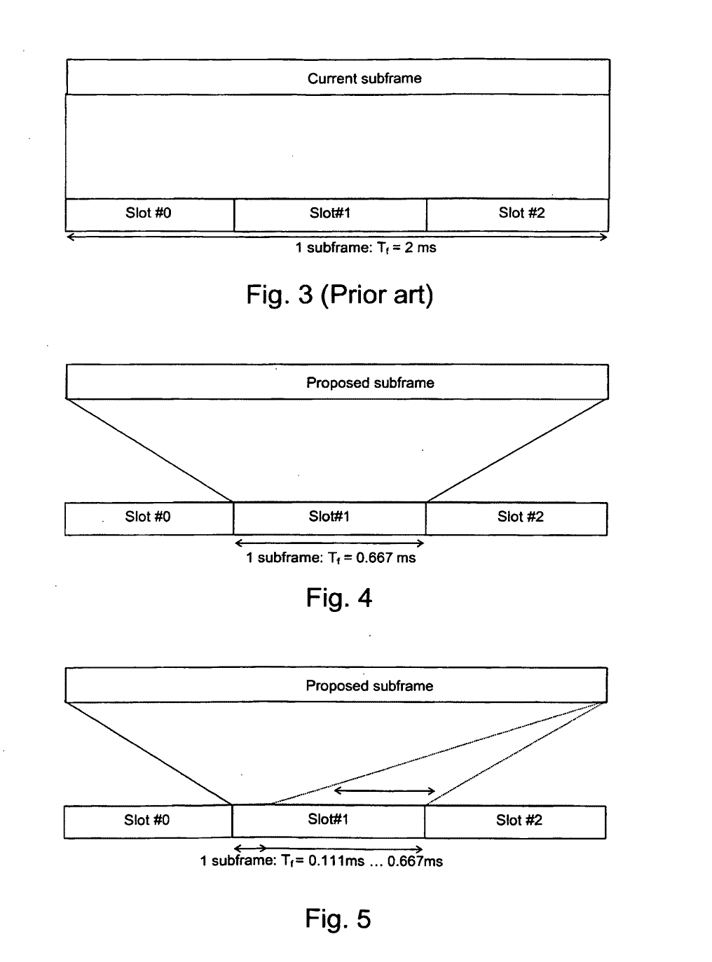

FIG. 3 presents the structure of a conventional subframe, which is used for packets addressed to a single terminal. The subframe corresponds to an entire HSDPA TTI, has a length T_{f} of 2 ms and comprises three time slots #0, #1 and #2.

In a first alternative according to the invention, in contrast, the packet scheduling component 14 selects a fixed number of subframes per TTI. The fixed number can be in particular three, such that each subframe corresponds to one timeslot of a TTI and has a length of T_{f}=0.667 ms. This first alternative is illustrated in FIG. 4.

In a second alternative according to the invention, the packet scheduling component 14 selects a variable number of subframes per TTI. The number of subframes may be selected depending on the current capacity on the radio interface and on the data-rate currently needed for the terminals of the group. The variable number may lie for instance between three and eighteen. In the case of three subframes, each subframe has thus again a length of T_{f}=0.667 ms, while in the case of eighteen subframes, each subframe has a length of T_{f}=0.111 ms. It is to be understood, though, that in practice, the number of possible subframes may be limited for reasons of simplicity. This second alternative is illustrated in FIG. 5.

Next, the packet scheduling component 14 associates each of the determined subframes to terminals of a group of terminals. (step 217).

In both alternatives described with reference to FIGS. 4 and 5, the distribution of the subframes to the terminals 20, 30, 40 can vary for each TTI.

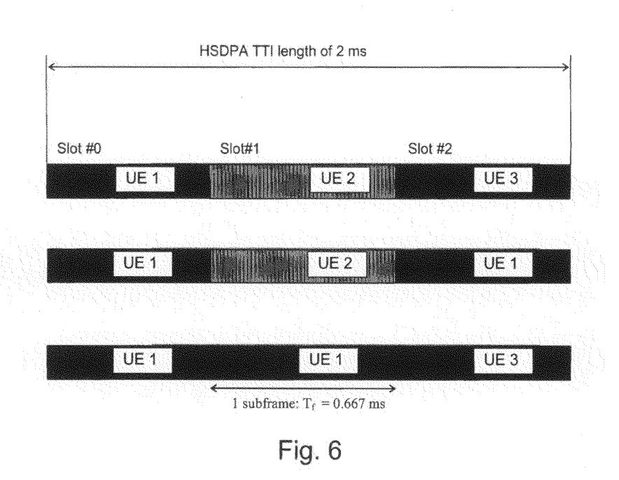

FIG. 6 presents in three horizontal rows three exemplary distributions for the first alternative described with reference to FIG. 4. In each row, a TTI having a length of 2 ms is depicted. The TTI is composed of three time slots #0, #1, #2 having a length of 0.667 ms, each timeslot corresponding to one subframe.

In the first row, the timeslots are associated in this order to terminal UE1 20, terminal UE2 30 and terminal UE3 40. In the second row, the timeslots are associated in this order to terminal UE1 20, terminal UE2 30 and again to terminal UE1 20. In the third row, the timeslots are associated in this order to terminal UE1 20, again to terminal UE1 20 and to terminal UE3 40. Thus, several subframes of a TTI may also be associated to a single terminal, and these subframes may or may not be next to each other.

The packet scheduling component 14 then transmits a message on the HS-SCCH which includes the common H-RNTI (step 218).

The terminal 20 receives the message on the HS-SCCH. The TTI selection component 22 of the terminal 20 detects that a registered H-RNTI is included in a received message (step 222). As a result is knows, that the next TTI boundary belongs to a TTI that might comprise packets for the terminal 20.

The packet scheduling component 14 of the NodeB 10 transmits packets addressed to various terminals 20, 30, 40 at different bit positions in a TTI of the HS-DSCH. Each of these bit positions corresponds to the first bit of a subframes associated to the respective terminal 20, 30, 40. The packets can be scrambled and/or ciphered on a subframe basis in order to prevent eavesdropping. Alternative, the entire data stream for a respective terminal 20, 30, 40 could be scrambled and/or ciphered already at higher layers. In case the number of subframes is selected flexibly, some interleaving gain is enabled as well.

In addition, the packet scheduling component 14 signals to each terminal 20, 30, 40 an indication at which bit position in the TTI a packet addressed to the respective terminal 20, 30, 40 can be found. This indication may be transmitted for example as in-band signaling multiplexed with the HS-DSCH data into the TTI. (step 219)

It is to be understood that the indication at which position data for the terminal 20 is included in the TTI could also be provided separately from the packets. It could be provided for example as a higher layer signaling, like the RRC signaling described in the above mentioned specification TS 25.331. Further, it could be provided for example as explicit layer 1 signaling, for instance on the HS-SCCH described in the technical specification 3 GPP TS 25.212 V6.3.0 (2004-12): “Multiplexing and channel coding (FDD)” (Release 6). It could moreover be provided for example as implicit layer 1 signaling, for instance by an UE ID masking or a coloring of the data part.

The indication of the relevant position is received by the terminal 20 and forwarded to the packet extraction component 23. The packet extraction component 23 extracts thereupon those packets included in the TTI which are associated to the terminal 20. (step 223)

The extracted packets are then provided for a further processing to the packet processing component 24. This processing may comprise in particular, though not exclusively, a descrambling and deciphering of the packets. (step 224)

Summarized, the presented system enables an instruction of several terminals to receiver a shared TTI.

It is to be noted that the described embodiment constitutes only one of a variety of possible embodiments of the invention.

1. Method for supporting a transmission of data packets on a transmission channel, said method comprising at a transmitting device:
assigning at least one identifier in common to at least two receiving devices;
signaling said at least one identifier to each of said at least two receiving devices; and
announcing a respective transmission of data packets for at least one of said at least two receiving devices on said transmission channel by signaling said at least one identifier.

2. Method according to claim 1, wherein said at least one identifier is a single identifier.

3. Method according to claim 1, wherein said at least one identifier belongs to a respective set of identifiers assigned to each of said at least two receiving devices, and wherein each set of identifiers is signaled to a respective one of said at least two receiving devices to which said set of identifiers is assigned.

4. Method according to claim 1, wherein data packets are transmitted on said transmission channel in fixed transmission time intervals, and wherein a transmission of data packets for at least one of said at least two receiving devices in a respective transmission time interval is announced by signaling said at least one identifier.

5. Method according to claim 4, further comprising dividing a transmission time interval in which data packets for at least one of said at least two receiving devices is to be transmitted into at least two sub intervals, and associating at least one of said sub intervals to a respective one of said at least two receiving devices, each sub interval being used for transmitting data packets for an associated receiving

6. Method according to claim 5, wherein each transmission time interval comprises a predetermined number of timeslots, and wherein a transmission time interval, in which data packets for at least one of said at least two receiving devices is to be transmitted, is divided into sub intervals corresponding to a respective timeslot.

7. Method according to claim 5, wherein each transmission time interval, in which data packets for at least one of said at least two receiving devices is to be transmitted, is divided into a number of sub intervals, which number is determined based on at least one of the current transmission capacity and the currently required data rate.

8. Method according to claim 4, wherein said transmission time intervals are High Speed Downlink Packet Access Transmission Time Intervals having a length of two milliseconds.

9. Method according to claim 5, further comprising signaling a position of a sub interval in a respective transmission time interval to an associated receiving device.

10. Method according to claim 9, wherein said position is signaled in form of at least one of:
a higher layer signaling;
an explicit layer 1 signaling;
an implicit layer 1 signaling; and
an in-band signaling.

11. Method according to claim 1, further comprising applying at least one of a scrambling and a ciphering on data packets that are to be transmitted to one of said at least two receiving devices.

12. Method according to claim 1, further comprising at one of said at least two receiving devices.
receiving and detecting said at least one identifier, which is assigned in common to said at least two receiving devices;
receiving and detecting a corresponding identifier announcing a transmission of data packets for at least one of said at least two receiving devices; and
extracting data packets for said receiving device from data packets on said transmission channel announced by said identifier.

13. Method for supporting a reception of data packets on a transmission channel, said method comprising at a receiving devices:
receiving and registering at least one identifier, which registered identifier has been assigned by a transmitting device in common to said receiving device and at least one further receiving device;
receiving and detecting an identifier, which detected identifier corresponds to a registered identifier, in case said registered identifier is used by a transmitting device for announcing a transmission of data packets for at least one of said receiving device and at least one further receiving device; and
extracting data packets for said receiving device from data packets on said transmission channel announced by said detected identifier.

14. Transmitting device supporting a transmission of data packets on a transmission channel, said transmitting device comprising a processor configured to:
assign at least one identifier in common to at least two receiving devices;
cause a signaling of said at least one identifier to each of said at least two receiving devices; and
announce a respective transmission of data packets for at least one of said at least two receiving devices on said transmission channel by causing a signaling of said at least one identifier.

15. Transmitting device according to claim 14, wherein said transmitting device is a network element of a communication network.

16. Transmitting device according to claim 14, wherein said transmitting device is one of a base station and a radio network controller of a mobile communication network.

17. Receiving device supporting a reception of data packets on a transmission channel, said receiving device Comprising a processor configured to:
register at least one identifier received by said receiving device, which registered identifier has been assigned by a transmitting device in common to said receiving device and at least one further receiving device;
detect an identifier received by said receiving device and corresponding to a registered identifier, in case said registered identifier is used by a transmitting device for announcing a transmission of data packets for at least one of said receiving device and at least one further receiving device; and
extract data packets for said receiving device from data packets on said transmission channel announced by a detected identifier.

18. Receiving device according to claim 17, wherein said receiving device is a user equipment entity.

19. Communication system comprising a transmitting device according to claim 14 and at least one receiving device supporting a reception of data packets on a transmission channel, said receiving device comprising a processor configured to:
register at least one identifier received by said receiving device, which registered identifier has been assigned by a transmitting device in common to said receiving device and at least one further receiving device:
detect an identifier received by said receiving device and corresponding to a registered identifier, in case said registered identifier is used by a transmitting device for announcing a transmission of data packets for at least one of said receiving device and at least one further receiving device; and
extract data packets for said receiving device from data packets on said transmission channel announced by a detected identifier.

20. A chip for a transmitting device supporting a transmission of data packets on a transmission channel, said chip comprising:
a hardware portion adapted to assign at least one identifier in common to at least two receiving devices;
a hardware portion adapted to cause a signaling of said at least one identifier to each of said at least two receiving devices; and
a hardware portion adapted to announce a respective transmission of data packets for at least one of said at least two receiving devices on said transmission channel by causing a signaling of said at least one identifier.

21. A chip for a receiving device supporting a reception of data packets on a transmission channel, said chip comprising:
a hardware portion adapted to register at least one identifier received by said receiving device, which registered identifier has been assigned by a transmitting device in common to said receiving device and at least one further receiving device;
a hardware portion adapted to detect an identifier received by said receiving device and corresponding to a registered identifier, in case said registered identifier is used by a transmitting device for announcing a transmission of data packets for at least one of said receiving device and at least one further receiving device; and
a hardware portion adapted to extract data packets for said receiving device from data packets on said transmission channel announced by a detected identifier.

22. A computer readable medium having software code stored thereon for supporting a transmission of data packets on a transmission channel, said software code realizing the following steps when running in a processing unit of a transmitting device:
assigning at least one identifier in common to at least two receiving devices;
causing a signaling of said at least one identifier to each of said at least two receiving devices; and
announcing a respective transmission of data packets for at least one of said at least two receiving devices on said transmission channel by causing a signaling of said at least one identifier.

23. (canceled)

24. A computer readable medium having software code stored thereon for supporting a reception of data packets on a transmission channel, said software code realizing the following steps when running in a processing unit of a receiving device:
registering at least one identifier received by said receiving device, which registered identifier has been assigned by a transmitting device in common to said receiving device and at least one further receiving device;
detecting an identifier received by said receiving device, which detected identifier corresponds to a registered identifier, in case said registered identifier is used by a transmitting device for announcing a transmission of data packets for at least one of said receiving device and at least one further receiving device; and
extracting data packets for said receiving device from data packets on said transmission channel announced by said detected identifier.

25. (canceled)
